(19) United States
(12) Patent Application Publication
(10) Pub. No.: US 2026/0339377 A1
(43) Pub. Date: Oct. 29, 2026

(54) PEDAL SYSTEM FOR A VEHICLE

(71) Applicant: HL MANDO CORPORATION, Gyeonggi-do (KR)

(72) Inventors: SooYong JEON, Gyeonggi-do (KR); Heejun KIM, Gyeonggi-do (KR); Hyundong KIM, Gyeonggi-do (KR); Sungjun HONG, Gyeonggi-do (KR)

(21) Appl. No.: 19/661,624

(22) Filed: Apr. 28, 2026

(30) Foreign Application Priority Data
Apr. 29, 2025 (KR) 10-2025-0056385

(51) Int. Cl. G05G 5/03; B60K 26/02; B60K 28/10; B60T 7/04; B60T 17/22; B60W 10/04; B60W 10/18; G05G 1/44

(52) U.S. Cl. CPC G05G 5/03; B60K 26/021; B60K 28/10; B60T 7/042; B60T 17/221; B60W 10/04; B60W 10/18; G05G 1/44; G05G 2505/00

(57) ABSTRACT

A pedal system for a vehicle is disclosed. The pedal system for a vehicle may include a pedal mounted to the vehicle; a pedal simulator connected to the pedal and configured to provide, to the pedal, a reaction force corresponding to a pressure applied to the pedal; a first sensor configured to detect information related to operation of the pedal; a second sensor configured to detect information related to operation of the pedal simulator; a third sensor configured to detect, separately from the first sensor and the second sensor, information related to operation of the pedal or the pedal simulator; and a controller configured to brake or accelerate the vehicle using at least one of sensing information of the first sensor, sensing information of the second sensor, or sensing information of the third sensor.

### CROSS-REFERENCE TO RELATED APPLICATION

This application claims priority to and benefit from Korean Patent Application No. 10-2025-0056385, filed on Apr. 29, 2025, the disclosure of which is incorporated herein by reference to the extent permitted by law.

### TECHNICAL FIELD

The present disclosure relates to a pedal system for a vehicle, and more particularly, to a pedal system for a vehicle that brakes or accelerates the vehicle based on operation information of a pedal mounted to the vehicle.

### RELATED ART

A vehicle is provided with an accelerator pedal for acceleration of the vehicle and a brake pedal for deceleration of the vehicle. Recently, as various electronic control functions have been mounted to vehicles, pedal systems have been widely used in which, when a driver of a vehicle depresses a pedal of the vehicle, a sensor detects operation of the pedal, and braking of the vehicle or the like is performed based on a result of the detection.

In such a pedal system for a vehicle, when operation information of the pedal is not accurately detected, control of the vehicle according to an intention of the driver cannot be achieved. In particular, when operation information of the brake pedal is incorrectly detected or is not detected, an accident of the vehicle may occur.

### SUMMARY

An object of the present disclosure is to provide a pedal system for a vehicle capable of accurately recognizing operation information of a pedal mounted to the vehicle.

Another object of the present disclosure is to provide a pedal system having improved reliability through securing redundancy of a function related to recognition of operation of a pedal mounted to the vehicle.

The objects of the present disclosure are not limited to the above-described objects, and other objects that are not mentioned will be able to be clearly understood by those skilled in the art to which the present disclosure pertains from the following description.

According to an aspect of the present disclosure, provided is a pedal system for a vehicle, comprising: a pedal mounted to the vehicle; a pedal simulator connected to the pedal and configured to provide, to the pedal, a reaction force corresponding to a pressure applied to the pedal; a first sensor configured to detect information related to operation of the pedal; a second sensor configured to detect information related to operation of the pedal simulator; a third sensor configured to detect, separately from the first sensor and the second sensor, information related to operation of the pedal or the pedal simulator; and a controller configured to brake or accelerate the vehicle using at least one of sensing information of the first sensor, sensing information of the second sensor, or sensing information of the third sensor.

In the pedal system for a vehicle according to an aspect of the present disclosure, the third sensor may detect, separately from the first sensor, information related to operation of the pedal.

In the pedal system for a vehicle according to an aspect of the present disclosure, the third sensor may detect, separately from the second sensor, information related to operation of the pedal simulator.

In the pedal system for a vehicle according to an aspect of the present disclosure, the controller may brake or accelerate the vehicle based on an average value of the sensing information of the first sensor, the sensing information of the second sensor, and the sensing information of the third sensor if a difference between the sensing information of the first sensor and the sensing information of the second sensor, a difference between the sensing information of the first sensor and the sensing information of the third sensor, and a difference between the sensing information of the second sensor and the sensing information of the third sensor are all within a set range.

In the pedal system for a vehicle according to an aspect of the present disclosure, the controller may brake or accelerate the vehicle based on one of the sensing information of the first sensor, the sensing information of the second sensor, or the sensing information of the third sensor if a difference between the sensing information of the first sensor and the sensing information of the second sensor, a difference between the sensing information of the first sensor and the sensing information of the third sensor, and a difference between the sensing information of the second sensor and the sensing information of the third sensor are all within a set range.

In the pedal system for a vehicle according to an aspect of the present disclosure, when two of a difference between the sensing information of the first sensor and the sensing information of the second sensor, a difference between the sensing information of the first sensor and the sensing information of the third sensor, and a difference between the sensing information of the second sensor and the sensing information of the third sensor are outside a set range, the controller may determine, as faulty, a sensor outputting sensing information commonly included in the two differences outside the set range among the first sensor, the second sensor, and the third sensor, and exclude the sensing information of the sensor determined as faulty from a basis of determination.

In the pedal system for a vehicle according to an aspect of the present disclosure, the pedal may be a brake pedal, and the controller may brake the vehicle based on the greatest value among the sensing information of the first sensor, the sensing information of the second sensor, and the sensing information of the third sensor if a difference between the sensing information of the first sensor and the sensing information of the second sensor, a difference between the sensing information of the first sensor and the sensing information of the third sensor, and a difference between the sensing information of the second sensor and the sensing information of the third sensor are all outside a set range.

In the pedal system for a vehicle according to an aspect of the present disclosure, the pedal may be an accelerator pedal, and the controller may accelerate the vehicle based on the smallest value among the sensing information of the first sensor, the sensing information of the second sensor, and the sensing information of the third sensor if a difference between the sensing information of the first sensor and the sensing information of the second sensor, a difference between the sensing information of the first sensor and the sensing information of the third sensor, and a difference between the sensing information of the second sensor and the sensing information of the third sensor are all outside a set range.

According to another aspect of the present disclosure, provided is a pedal system for a vehicle, comprising: a pedal mounted to the vehicle; a pedal simulator connected to the pedal and configured to provide a reaction force corresponding to a pressure applied to the pedal; a first pedal simulator sensor disposed in the pedal simulator and configured to detect information related to operation of the pedal simulator; a second pedal simulator sensor separately disposed in the pedal simulator from the first pedal simulator sensor and configured to detect information related to operation of the pedal simulator; a third pedal simulator sensor separately disposed in the pedal simulator from the first pedal simulator sensor and the second pedal simulator sensor and configured to detect information related to operation of the pedal simulator; and a controller configured to brake or accelerate the vehicle using at least one of sensing information of the first pedal simulator sensor, sensing information of the second pedal simulator sensor, or sensing information of the third pedal simulator sensor.

In the pedal system for a vehicle according to another aspect of the present disclosure, the controller may brake or accelerate the vehicle based on an average value of the sensing information of the first pedal simulator sensor, the sensing information of the second pedal simulator sensor, and the sensing information of the third pedal simulator sensor if a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are all within a set range.

In the pedal system for a vehicle according to another aspect of the present disclosure, the controller may brake or accelerate the vehicle based on one of the sensing information of the first pedal simulator sensor, the sensing information of the second pedal simulator sensor, or the sensing information of the third pedal simulator sensor if a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are all within a set range.

In the pedal system for a vehicle according to another aspect of the present disclosure, when two of a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are outside a set range, the controller may determine, as faulty, a sensor outputting sensing information commonly included in the two differences outside the set range among the first pedal simulator sensor, the second pedal simulator sensor, and the third pedal simulator sensor, and exclude the sensing information of the sensor determined as faulty from a basis of determination.

In the pedal system for a vehicle according to another aspect of the present disclosure, the pedal may be a brake pedal, and the controller may brake the vehicle based on the greatest value among the sensing information of the first pedal simulator sensor, the sensing information of the second pedal simulator sensor, and the sensing information of the third pedal simulator sensor if a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are all outside a set range.

In the pedal system for a vehicle according to another aspect of the present disclosure, the pedal may be an accelerator pedal, and the controller may accelerate the vehicle based on the smallest value among the sensing information of the first pedal simulator sensor, the sensing information of the second pedal simulator sensor, and the sensing information of the third pedal simulator sensor if a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are all outside a set range.

According to still another aspect of the present disclosure, provided is a pedal system for a vehicle, comprising: a pedal mounted to the vehicle; a pedal simulator connected to the pedal and configured to provide a reaction force corresponding to a pressure applied to the pedal; a first pedal sensor configured to detect information related to operation of the pedal; a second pedal sensor separately disposed from the first pedal sensor and configured to detect information related to operation of the pedal; a third pedal sensor separately disposed from the first pedal sensor and the second pedal sensor and configured to detect information related to operation of the pedal; and a controller configured to brake or accelerate the vehicle using at least one of sensing information of the first pedal sensor, sensing information of the second pedal sensor, or sensing information of the third pedal sensor.

In the pedal system for a vehicle according to still another aspect of the present disclosure, the controller may brake or accelerate the vehicle based on an average value of the sensing information of the first pedal sensor, the sensing information of the second pedal sensor, and the sensing information of the third pedal sensor if a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are all within a set range.

In the pedal system for a vehicle according to still another aspect of the present disclosure, the controller may brake or accelerate the vehicle based on one of the sensing information of the first pedal sensor, the sensing information of the second pedal sensor, or the sensing information of the third pedal sensor if a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are all within a set range.

In the pedal system for a vehicle according to still another aspect of the present disclosure, when two of a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are outside a set range, the controller may determine, as faulty, a sensor outputting sensing information commonly included in the two differences outside the set range among the first pedal sensor, the second pedal sensor, and the third pedal sensor, and exclude the sensing information of the sensor determined as faulty from a basis of determination.

In the pedal system for a vehicle according to still another aspect of the present disclosure, the pedal may be a brake pedal, and the controller may brake the vehicle based on the greatest value among the sensing information of the first pedal sensor, the sensing information of the second pedal sensor, and the sensing information of the third pedal sensor if a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are all outside a set range.

In the pedal system for a vehicle according to still another aspect of the present disclosure, the pedal may be an accelerator pedal, and the controller may accelerate the vehicle based on the smallest value among the sensing information of the first pedal sensor, the sensing information of the second pedal sensor, and the sensing information of the third pedal sensor if a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are all outside a set range.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating a configuration of a pedal system for a vehicle according to a first embodiment of the present disclosure.

FIG. 2 illustrates a case in the first embodiment of the present disclosure in which a fluid is filled in a pedal simulator and a third sensor is disposed to detect a hydraulic pressure.

FIG. 3 illustrates a case in the first embodiment of the present disclosure in which a fluid is filled in the pedal simulator, a second sensor detects a pressure applied to a damper of the pedal simulator, and a third sensor is disposed to detect a hydraulic pressure.

FIG. 4 is a view illustrating a case in the first embodiment of the present disclosure in which the second sensor detects displacement of a piston of the pedal simulator and the third sensor is disposed on a pedal side.

FIG. 5 is a view illustrating a case in the first embodiment of the present disclosure in which the second sensor detects a force applied to a damper of the pedal simulator and the third sensor is disposed on the pedal side.

FIG. 6 is a view illustrating a case in which a fluid is filled in the pedal simulator, the second sensor detects a hydraulic pressure, and the third sensor is disposed on the pedal side.

FIG. 7 is a view illustrating a configuration of a pedal system for a vehicle according to a second embodiment of the present disclosure.

FIG. 8 is a view illustrating a configuration of a pedal system for a vehicle according to a third embodiment of the present disclosure.

FIG. 9 is a view illustrating a configuration of a pedal system for a vehicle according to a fourth embodiment of the present disclosure.

FIG. 10 is a view illustrating a configuration of a pedal system for a vehicle according to a fifth embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

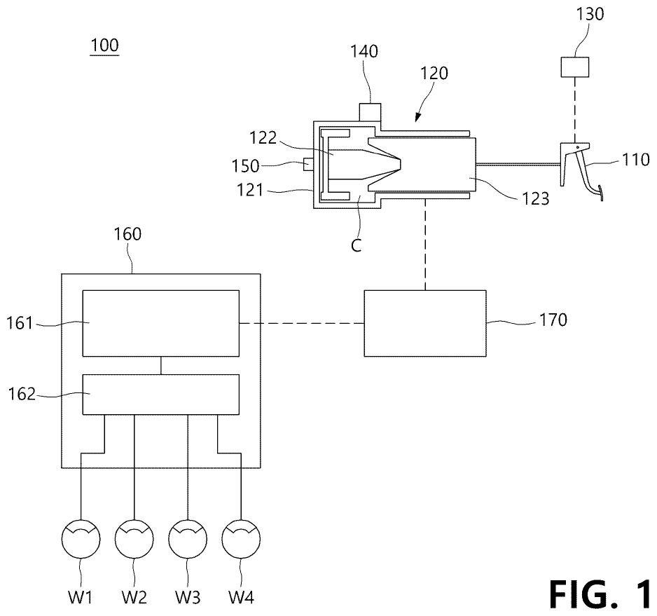

FIG. 1 is a view illustrating a configuration of a pedal system for a vehicle according to a first embodiment of the present disclosure.

A pedal system 100 for a vehicle according to the first embodiment of the present disclosure may brake the vehicle based on operation information of a pedal 110 mounted to the vehicle. In other words, the pedal system 100 for a vehicle may be a brake pedal system of the vehicle.

Referring to FIG. 1, the pedal system 100 for a vehicle according to the first embodiment of the present disclosure includes a pedal 110, a pedal simulator 120, a first sensor 130, a second sensor 140, a third sensor 150, a brake actuation device 160, and a controller 170.

The pedal 110 is mounted to the vehicle. The pedal 110 may be operated by a driver. In the first embodiment of the present disclosure, the pedal 110 may be a brake pedal.

The pedal simulator 120 is connected to the pedal 110 and provides, to the pedal 110, a reaction force corresponding to a pressure applied to the pedal 110.

The pedal simulator 120 may include a housing 121 defining a chamber C therein, a damper 122 disposed inside the housing 121, and a piston 123 connected to the pedal 110 and disposed in the chamber C to press the damper 122 when pressure is applied to the pedal 110.

The chamber C of the pedal simulator 120 may not be filled with a fluid therein. In this case, the pedal simulator 120 may be defined as a dry type. Meanwhile, the chamber C of the pedal simulator 120 may be filled with a fluid therein. In this case, the pedal simulator 120 may be defined as a wet type.

The first sensor 130 detects information related to operation of the pedal 110. The first sensor 130 may be connected to the pedal 110.

In the first embodiment of the present disclosure, the first sensor 130 may detect linear displacement of the pedal 110. Alternatively, the first sensor 130 may detect angular displacement of the pedal 110. Meanwhile, the first sensor 130 may also detect a force applied to the pedal 110.

The second sensor 140 detects information related to operation of the pedal simulator 120. The second sensor 140 may be disposed inside or outside the pedal simulator 120.

The second sensor 140 may detect linear displacement of the piston 123. More specifically, the second sensor 140 may detect the linear displacement of the piston 123 in an electromagnetic manner. For example, the pedal simulator 120 may include a magnet moving together with the piston 123, and the second sensor 140 may detect an intensity or change of a magnetic field formed by the magnet when the piston 123 is displaced.

The third sensor 150 may detect, separately from the first sensor 130 and the second sensor 140, information related to operation of the pedal 110 or the pedal simulator 120. In the first embodiment of the present disclosure, the third sensor 150 may be connected to the pedal simulator 120 separately from the second sensor 140 and may detect information related to operation of the pedal simulator 120.

The third sensor 150 may detect a pressure applied to the damper 122. For example, the third sensor 150 may be a force sensor disposed to detect the pressure applied to the damper 122.

The brake actuation device 160 performs braking of the vehicle under control of the controller 170. The brake actuation device 160 may supply a fluid to at least one of wheels W1, W2, W3, and W4 of the vehicle to provide a braking pressure.

The brake actuation device 160 may include an actuator 161 generating a pressure of the fluid and a hydraulic circuit 162 regulating a flow of the fluid between the actuator 161 and the wheels W1, W2, W3, and W4 of the vehicle. For example, the actuator 161 may be a motor pump. In addition, the hydraulic circuit 162 may include a flow path connecting the actuator 161 and the wheels W1, W2, W3, and W4 of the vehicle, and one or more valves regulating the flow of the fluid.

The controller 170 may brake the vehicle using at least one of sensing information of the first sensor 130, sensing information of the second sensor 140, or sensing information of the third sensor 150. For example, the controller 170 may determine a magnitude of displacement of the pedal 110 using at least one of the sensing information of the first sensor 130, the sensing information of the second sensor 140, or the sensing information of the third sensor 150, and may control the actuator 161 of the brake actuation device 160 such that a braking force corresponding thereto is generated.

The controller 170 may be configured as an MCU (Micro Controller Unit) or an ECU (Electronic Control Unit) mounted to the vehicle. The controller 170 may include at least one ALU (Arithmetic Logic Unit) and a processing register. In addition, the controller 170 may include a memory for storing data. In addition, the controller 170 may be a single control unit or may include a plurality of distributed control units.

The controller 170 may perform control in various manners. Hereinafter, several examples of a control manner of the controller 170 will be described.

First, if a difference between the sensing information of the first sensor 130 and the sensing information of the second sensor 140, a difference between the sensing information of the first sensor 130 and the sensing information of the third sensor 150, and a difference between the sensing information of the second sensor 140 and the sensing information of the third sensor 150 are all within a set range, the controller 170 may brake the vehicle based on an average value of the sensing information of the first sensor 130, the sensing information of the second sensor 140, and the sensing information of the third sensor 150.

For example, the set range may be set to a maximum error of the sensing information when the first sensor 130, the second sensor 140, and the third sensor 150 are all normal.

When differences among the sensing information of the first sensor 130, the second sensor 140, and the third sensor 150 are within the set range, the first sensor 130, the second sensor 140, and the third sensor 150 may all be regarded as operating normally. Accordingly, the controller 170 may determine that the pedal 110 has been displaced by a magnitude corresponding to the average value of the sensing information of the first sensor 130, the sensing information of the second sensor 140, and the sensing information of the third sensor 150, and may generate a control signal corresponding thereto and transmit the control signal to the actuator 161 of the brake actuation device 160.

Next, if a difference between the sensing information of the first sensor 130 and the sensing information of the second sensor 140, a difference between the sensing information of the first sensor 130 and the sensing information of the third sensor 150, and a difference between the sensing information of the second sensor 140 and the sensing information of the third sensor 150 are all within the set range, the controller 170 may brake the vehicle based on one of the sensing information of the first sensor 130, the sensing information of the second sensor 140, or the sensing information of the third sensor 150.

In other words, the controller 170 may use only one of the sensing information of the first sensor 130, the sensing information of the second sensor 140, or the sensing information of the third sensor 150 according to a preset criterion. In this regard, when the first sensor 130, the second sensor 140, and the third sensor 150 are all normal, the controller 170 may store preset information regarding which sensor is to be preferentially used.

Next, when two of a difference between the sensing information of the first sensor 130 and the sensing information of the second sensor 140, a difference between the sensing information of the first sensor 130 and the sensing information of the third sensor 150, and a difference between the sensing information of the second sensor 140 and the sensing information of the third sensor 150 are outside the set range, the controller 170 may determine, as faulty, a sensor outputting sensing information commonly included in the two differences outside the set range among the first sensor 130, the second sensor 140, and the third sensor 150. In addition, the controller 170 may exclude the sensing information of the sensor determined as faulty from a basis of determination.

For example, if a difference between the sensing information of the first sensor 130 and the sensing information of the second sensor 140 and a difference between the sensing information of the first sensor 130 and the sensing information of the third sensor 150 are outside the set range, the controller 170 may determine that the first sensor 130 is faulty.

In this case, the controller 170 may exclude the sensing information of the first sensor 130 and use the sensing information of the second sensor 140 or the sensing information of the third sensor 150. More specifically, the controller 170 may use an average value of the sensing information of the second sensor 140 and the sensing information of the third sensor 150. In addition, the controller 170 may use one of the sensing information of the second sensor 140 or the sensing information of the third sensor 150 according to a preset priority.

Next, if a difference between the sensing information of the first sensor 130 and the sensing information of the second sensor 140, a difference between the sensing information of the first sensor 130 and the sensing information of the third sensor 150, and a difference between the sensing information of the second sensor 140 and the sensing information of the third sensor 150 are all outside the set range, the controller 170 may brake the vehicle based on the greatest value among the sensing information of the first sensor 130, the sensing information of the second sensor 140, and the sensing information of the third sensor 150.

If a difference between the sensing information of the first sensor 130 and the sensing information of the second sensor 140, a difference between the sensing information of the first sensor 130 and the sensing information of the third sensor 150, and a difference between the sensing information of the second sensor 140 and the sensing information of the third sensor 150 are all outside the set range, at least two sensors may be regarded as being faulty.

Since the pedal system 100 for a vehicle according to the first embodiment of the present disclosure is related to braking of the vehicle, it is desirable, for safety, that excessive braking rather than insufficient braking be performed. Accordingly, if the differences among the three pieces of sensing information are all outside the set range, the controller 170 may control the actuator 161 of the brake actuation device 160 such that a braking force corresponding to the greatest value among the sensing information of the first sensor 130, the sensing information of the second sensor 140, and the sensing information of the third sensor 150 is generated. Meanwhile, the controller 170 may also perform braking control such that the vehicle is stopped.

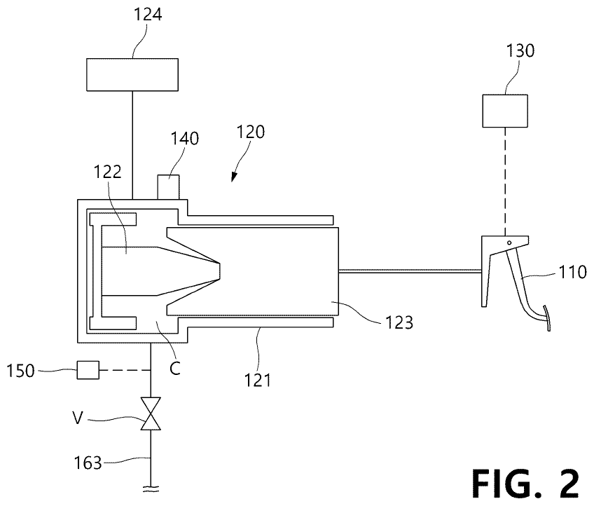

FIG. 2 illustrates a case in the first embodiment of the present disclosure in which a fluid is filled in a pedal simulator and a third sensor is disposed to detect a hydraulic pressure.

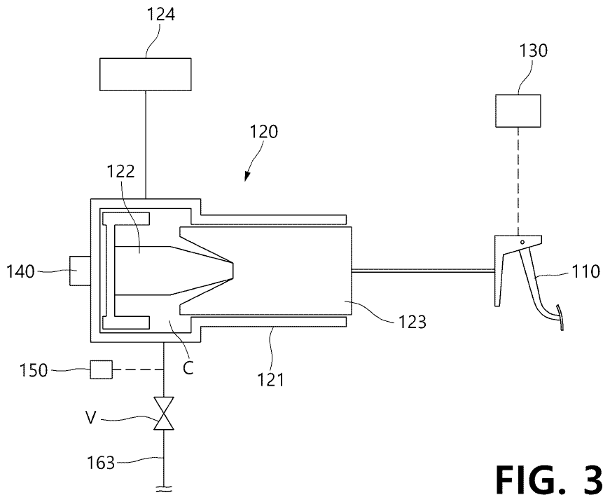

FIG. 3 illustrates a case in the first embodiment of the present disclosure in which a fluid is filled in the pedal simulator, a second sensor detects a pressure applied to a damper of the pedal simulator, and a third sensor is disposed to detect a hydraulic pressure.

Referring to FIGS. 2 and 3, the pedal simulator 120 is configured as a wet type in which the chamber C is filled with a fluid. When the fluid is filled in the pedal simulator 120 as described above, the pedal simulator 120 may be connected to an emergency hydraulic circuit 163 capable of delivering the fluid toward at least one wheel in a fall-back mode of the brake actuation device 160, that is, in a failure state.

When the brake actuation device 160 is in a normal state, a circuit opening/closing valve V disposed in the emergency hydraulic circuit 163 is disposed to close a flow path. At this time, the third sensor 150 may be disposed in the emergency hydraulic circuit 163 between the pedal simulator 120 and the circuit opening/closing valve V. More specifically, the third sensor 150 may detect a flow pressure of the fluid generated when the piston 123 is displaced by a pressure applied to the pedal 110.

When the brake actuation device 160 is in a normal state, the fluid does not need to be supplied to the emergency hydraulic circuit 163. In this regard, the pedal simulator 120 may further include a reservoir 124 for accommodating a flow of the fluid from the chamber C according to displacement of the pedal 110.

Meanwhile, referring to FIG. 3, the second sensor 140 may detect a pressure applied to the damper 122. That is, the second sensor 140 may be a force sensor disposed to detect a pressure applied to the damper 122, and the third sensor 150 may be a pressure sensor configured to detect a hydraulic pressure in the emergency hydraulic circuit 163.

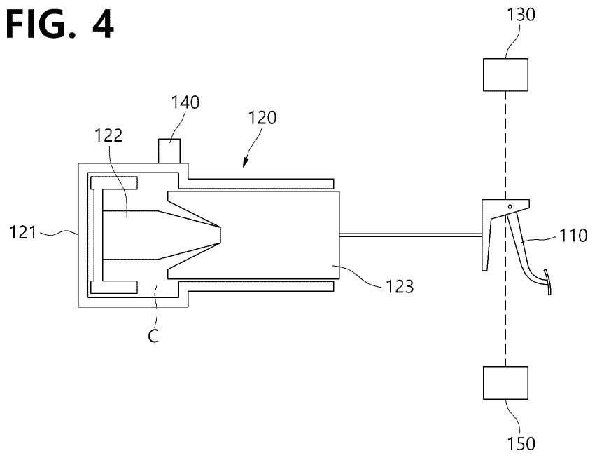

FIG. 4 is a view illustrating a case in the first embodiment of the present disclosure in which the second sensor detects displacement of a piston of the pedal simulator and the third sensor is disposed on a pedal side.

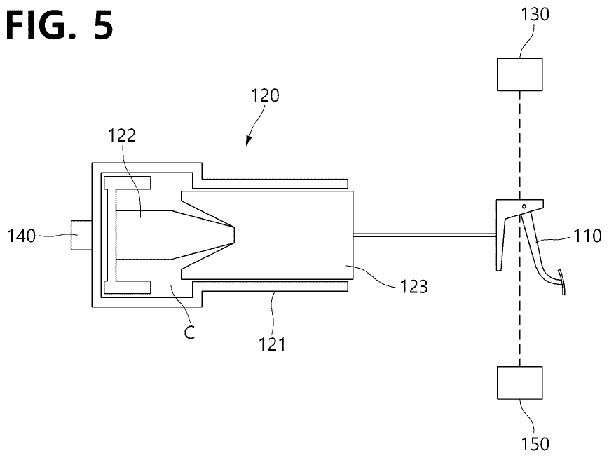

FIG. 5 is a view illustrating a case in the first embodiment of the present disclosure in which the second sensor detects a force applied to a damper of the pedal simulator and the third sensor is disposed on the pedal side.

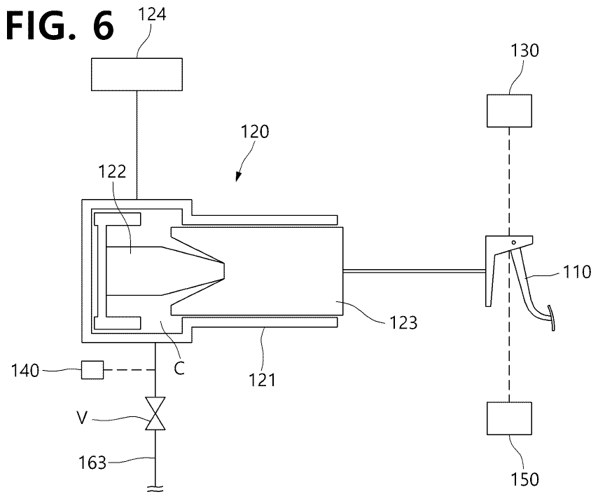

FIG. 6 is a view illustrating a case in which a fluid is filled in the pedal simulator, the second sensor detects a hydraulic pressure, and the third sensor is disposed on the pedal side.

Referring to FIGS. 4 to 6, the third sensor 150 may be connected to the pedal 110 separately from the first sensor 130 and may detect information related to operation of the pedal 110. More specifically, the first sensor 130 may detect linear displacement of the pedal 110, and the third sensor 150 may detect angular displacement of the pedal 110. In addition, the first sensor 130 may detect linear displacement of the pedal 110, and the third sensor 150 may detect a force applied to the pedal 110. In addition, the first sensor 130 may detect angular displacement of the pedal 110, and the third sensor 150 may also detect a force applied to the pedal 110.

Meanwhile, referring to FIG. 4, the second sensor 140 may detect linear displacement of the piston 123 of the pedal simulator 120. In addition, referring to FIG. 5, the second sensor 140 may detect a force applied to the damper 122 of the pedal simulator 120. In addition, referring to FIG. 6, a fluid is filled in the pedal simulator 120, and the second sensor 140 may detect a hydraulic pressure in the emergency hydraulic circuit 163.

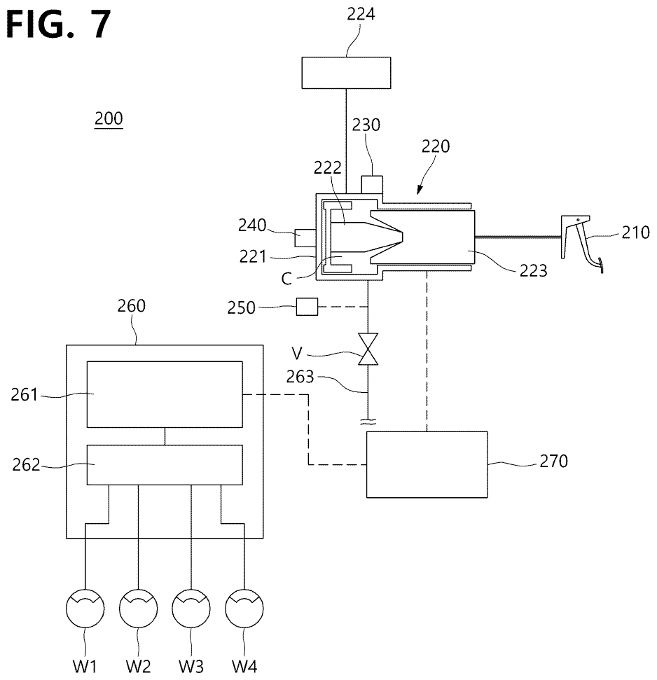

FIG. 7 is a view illustrating a configuration of a pedal system for a vehicle according to a second embodiment of the present disclosure.

A pedal system 200 for a vehicle according to the second embodiment of the present disclosure may brake the vehicle based on operation information of a pedal 210 mounted to the vehicle. In other words, the pedal system 200 for a vehicle according to the second embodiment of the present disclosure may be a brake pedal system of the vehicle.

Referring to FIG. 7, the pedal system 200 for a vehicle according to the second embodiment of the present disclosure includes a pedal 210, a pedal simulator 220, a first pedal simulator sensor 230, a second pedal simulator sensor 240, a third pedal simulator sensor 250, a brake actuation device 260, and a controller 270.

The pedal 210 is mounted to the vehicle. The pedal 210 may be a brake pedal.

The pedal simulator 220 is connected to the pedal 210 and provides, to the pedal 210, a reaction force corresponding to a pressure applied to the pedal 210.

The pedal simulator 220 may include a housing 221 defining a chamber C therein, a damper 222 disposed inside the housing 221, and a piston 223 connected to the pedal 210 and disposed in the chamber C to press the damper 222 when pressure is applied to the pedal 210.

The pedal simulator 220 is configured as a wet type in which a fluid is filled in the chamber C. At this time, the pedal simulator 220 is connected to an emergency hydraulic circuit 263 capable of delivering the fluid toward at least one wheel. When the brake actuation device 260 is in a normal state, a circuit opening/closing valve V disposed in the emergency hydraulic circuit 263 is disposed to close a flow path.

The first pedal simulator sensor 230 detects information related to operation of the pedal simulator 220. For example, the first pedal simulator sensor 230 may detect linear displacement of the piston 223. More specifically, the first pedal simulator sensor 230 may detect the linear displacement of the piston 223 in an electromagnetic manner.

The second pedal simulator sensor 240 is separately disposed in the pedal simulator 220 from the first pedal simulator sensor 230 and detects information related to operation of the pedal simulator 220. For example, the second pedal simulator sensor 240 may detect a pressure applied to the damper 222.

The third pedal simulator sensor 250 is separately disposed in the pedal simulator 220 from the first pedal simulator sensor 230 and the second pedal simulator sensor 240 and detects information related to operation of the pedal simulator 220.

The third pedal simulator sensor 250 may be disposed in the emergency hydraulic circuit 263 between the pedal simulator 220 and the circuit opening/closing valve V. More specifically, the third pedal simulator sensor 250 may detect a flow pressure of the fluid generated when the piston 223 is displaced by a pressure applied to the pedal 210.

The brake actuation device 260 performs braking of the vehicle under control of the controller 270. The brake actuation device 260 may supply a fluid to at least one of wheels W1, W2, W3, and W4 of the vehicle to provide a braking pressure.

The brake actuation device 260 may include an actuator 261 generating a pressure of the fluid and a hydraulic circuit 262 regulating a flow of the fluid between the actuator 261 and the wheels W1, W2, W3, and W4 of the vehicle.

The controller 270 may brake the vehicle using at least one of sensing information of the first pedal simulator sensor 230, sensing information of the second pedal simulator sensor 240, or sensing information of the third pedal simulator sensor 250.

The controller 270 may perform control as follows.

First, if a difference between the sensing information of the first pedal simulator sensor 230 and the sensing information of the second pedal simulator sensor 240, a difference between the sensing information of the first pedal simulator sensor 230 and the sensing information of the third pedal simulator sensor 250, and a difference between the sensing information of the second pedal simulator sensor 240 and the sensing information of the third pedal simulator sensor 250 are all within a set range, the controller 270 may brake the vehicle based on an average value of the sensing information of the first pedal simulator sensor 230, the sensing information of the second pedal simulator sensor 240, and the sensing information of the third pedal simulator sensor 250.

For example, the set range may be set to a maximum error of the sensing information when the first pedal simulator sensor 230, the second pedal simulator sensor 240, and the third pedal simulator sensor 250 are all normal.

Next, if a difference between the sensing information of the first pedal simulator sensor 230 and the sensing information of the second pedal simulator sensor 240, a difference between the sensing information of the first pedal simulator sensor 230 and the sensing information of the third pedal simulator sensor 250, and a difference between the sensing information of the second pedal simulator sensor 240 and the sensing information of the third pedal simulator sensor 250 are all within the set range, the controller 270 may brake the vehicle based on one of the sensing information of the first pedal simulator sensor 230, the sensing information of the second pedal simulator sensor 240, or the sensing information of the third pedal simulator sensor 250.

In this regard, when the first pedal simulator sensor 230, the second pedal simulator sensor 240, and the third pedal simulator sensor 250 are all normal, the controller 270 may store preset information regarding which sensor is to be preferentially used.

Next, when two of a difference between the sensing information of the first pedal simulator sensor 230 and the sensing information of the second pedal simulator sensor 240, a difference between the sensing information of the first pedal simulator sensor 230 and the sensing information of the third pedal simulator sensor 250, and a difference between the sensing information of the second pedal simulator sensor 240 and the sensing information of the third pedal simulator sensor 250 are outside the set range, the controller 270 may determine, as faulty, a sensor outputting sensing information commonly included in the two differences outside the set range among the first pedal simulator sensor 230, the second pedal simulator sensor 240, and the third pedal simulator sensor 250. In addition, the controller 270 may exclude the sensing information of the sensor determined as faulty from a basis of determination.

Next, if a difference between the sensing information of the first pedal simulator sensor 230 and the sensing information of the second pedal simulator sensor 240, a difference between the sensing information of the first pedal simulator sensor 230 and the sensing information of the third pedal simulator sensor 250, and a difference between the sensing information of the second pedal simulator sensor 240 and the sensing information of the third pedal simulator sensor 250 are all outside the set range, the controller 270 may brake the vehicle based on the greatest value among the sensing information of the first pedal simulator sensor 230, the sensing information of the second pedal simulator sensor 240, and the sensing information of the third pedal simulator sensor 250. Meanwhile, the controller 270 may also perform braking control such that the vehicle is stopped.

In addition, a detailed configuration of the controller 270 and reasons for and examples of the above control manner are the same as those described in the first embodiment.

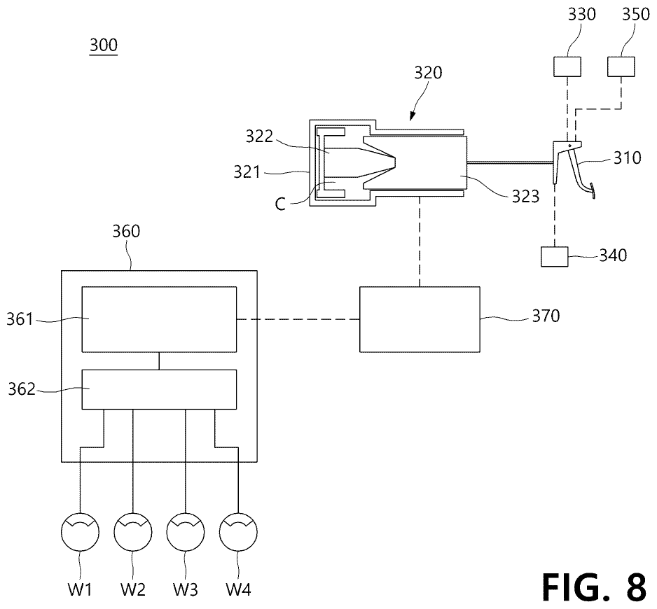

FIG. 8 is a view illustrating a configuration of a pedal system for a vehicle according to a third embodiment of the present disclosure.

A pedal system 300 for a vehicle according to the third embodiment of the present disclosure may brake the vehicle based on operation information of a pedal 310 mounted to the vehicle. In other words, the pedal system 300 for a vehicle according to the third embodiment of the present disclosure may be a brake pedal system of the vehicle.

Referring to FIG. 8, the pedal system 300 for a vehicle according to the third embodiment of the present disclosure includes a pedal 310, a pedal simulator 320, a first pedal sensor 330, a second pedal sensor 340, a third pedal sensor 350, a brake actuation device 360, and a controller 370.

The pedal 310 is mounted to the vehicle. The pedal 310 may be a brake pedal.

The pedal simulator 320 is connected to the pedal 310 and provides, to the pedal 310, a reaction force corresponding to a pressure applied to the pedal 310.

The pedal simulator 320 may include a housing 321 defining a chamber C therein, a damper 322 disposed inside the housing 321, and a piston 323 connected to the pedal 310 and disposed in the chamber C to press the damper 322 when pressure is applied to the pedal 310.

The first pedal sensor 330 detects information related to operation of the pedal 310. The first pedal sensor 330 may be connected to the pedal 310. For example, the first pedal sensor 330 may detect linear displacement of the pedal 310.

The second pedal sensor 340 is separately disposed from the first pedal sensor 330 and detects information related to operation of the pedal 310. For example, the second pedal sensor 340 may detect angular displacement of the pedal 310.

The third pedal sensor 350 is separately disposed from the first pedal sensor 330 and the second pedal sensor 340. The third pedal sensor 350 detects information related to operation of the pedal 310. For example, the third pedal sensor 350 may detect a force applied to the pedal 310.

The brake actuation device 360 performs braking of the vehicle under control of the controller 370. The brake actuation device 360 may supply a fluid to at least one of wheels W1, W2, W3, and W4 of the vehicle to provide a braking pressure.

The brake actuation device 360 may include an actuator 361 generating a pressure of the fluid and a hydraulic circuit 362 regulating a flow of the fluid between the actuator 361 and the wheels W1, W2, W3, and W4 of the vehicle.

The controller 370 may brake the vehicle using at least one of sensing information of the first pedal sensor 330, sensing information of the second pedal sensor 340, or sensing information of the third pedal sensor 350.

The controller 370 may perform control as follows.

First, if a difference between the sensing information of the first pedal sensor 330 and the sensing information of the second pedal sensor 340, a difference between the sensing information of the first pedal sensor 330 and the sensing information of the third pedal sensor 350, and a difference between the sensing information of the second pedal sensor 340 and the sensing information of the third pedal sensor 350 are all within a set range, the controller 370 may brake the vehicle based on an average value of the sensing information of the first pedal sensor 330, the sensing information of the second pedal sensor 340, and the sensing information of the third pedal sensor 350.

For example, the set range may be set to a maximum error of the sensing information when the first pedal sensor 330, the second pedal sensor 340, and the third pedal sensor 350 are all normal.

Next, if a difference between the sensing information of the first pedal sensor 330 and the sensing information of the second pedal sensor 340, a difference between the sensing information of the first pedal sensor 330 and the sensing information of the third pedal sensor 350, and a difference between the sensing information of the second pedal sensor 340 and the sensing information of the third pedal sensor 350 are all within the set range, the controller 370 may brake the vehicle based on one of the sensing information of the first pedal sensor 330, the sensing information of the second pedal sensor 340, or the sensing information of the third pedal sensor 350.

In this regard, when the first pedal sensor 330, the second pedal sensor 340, and the third pedal sensor 350 are all normal, the controller 370 may store preset information regarding which sensor is to be preferentially used.

Next, when two of a difference between the sensing information of the first pedal sensor 330 and the sensing information of the second pedal sensor 340, a difference between the sensing information of the first pedal sensor 330 and the sensing information of the third pedal sensor 350, and a difference between the sensing information of the second pedal sensor 340 and the sensing information of the third pedal sensor 350 are outside the set range, the controller 370 may determine, as faulty, a sensor outputting sensing information commonly included in the two differences outside the set range among the first pedal sensor 330, the second pedal sensor 340, and the third pedal sensor 350. In addition, the controller 370 may exclude the sensing information of the sensor determined as faulty from a basis of determination.

Next, if a difference between the sensing information of the first pedal sensor 330 and the sensing information of the second pedal sensor 340, a difference between the sensing information of the first pedal sensor 330 and the sensing information of the third pedal sensor 350, and a difference between the sensing information of the second pedal sensor 340 and the sensing information of the third pedal sensor 350 are all outside the set range, the controller 370 may brake the vehicle based on the greatest value among the sensing information of the first pedal sensor 330, the sensing information of the second pedal sensor 340, and the sensing information of the third pedal sensor 350. Meanwhile, the controller 370 may also perform braking control such that the vehicle is stopped.

In addition, a detailed configuration of the controller 370 and reasons for and examples of the above control manner are the same as those described in the first embodiment.

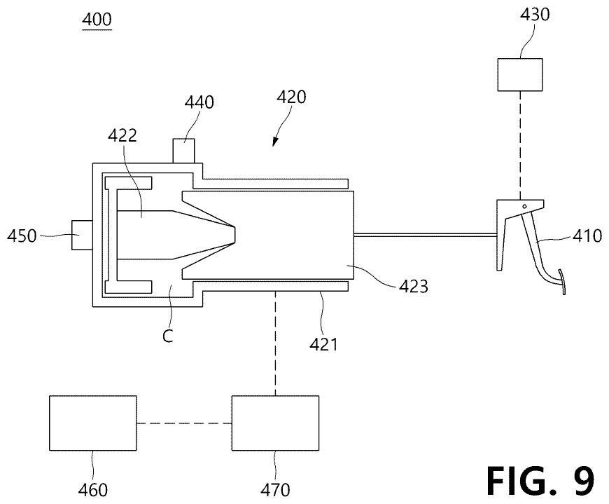

FIG. 9 is a view illustrating a configuration of a pedal system for a vehicle according to a fourth embodiment of the present disclosure.

A pedal system 400 for a vehicle according to the fourth embodiment of the present disclosure may accelerate the vehicle based on operation information of a pedal 410 mounted to the vehicle. In other words, the pedal system 400 for a vehicle may be an accelerator pedal system of the vehicle.

Referring to FIG. 9, the pedal system 400 for a vehicle according to the fourth embodiment of the present disclosure includes a pedal 410, a pedal simulator 420, a first sensor 430, a second sensor 440, a third sensor 450, an acceleration device 460, and a controller 470.

The pedal 410 is mounted to the vehicle. The pedal 410 may be operated by a driver. In the fourth embodiment of the present disclosure, the pedal 410 may be an accelerator pedal.

The pedal simulator 420 is connected to the pedal 410 and provides, to the pedal 410, a reaction force corresponding to a pressure applied to the pedal 410.

The pedal simulator 420 may include a housing 421 defining a chamber C therein, a damper 422 disposed inside the housing 421, and a piston 423 connected to the pedal 410 and disposed in the chamber C to press the damper 422 when pressure is applied to the pedal 410.

The first sensor 430 detects information related to operation of the pedal 410. The first sensor 430 may be connected to the pedal 410.

The first sensor 430 may detect linear displacement of the pedal 410. Alternatively, the first sensor 430 may detect angular displacement of the pedal 410. Meanwhile, the first sensor 430 may also detect a force applied to the pedal 410.

The second sensor 440 detects information related to operation of the pedal simulator 420. The second sensor 440 may be disposed inside or outside the pedal simulator 420. More specifically, the second sensor 440 may detect linear displacement of the piston 423.

The third sensor 450 is separately disposed from the second sensor 440 and detects information related to operation of the pedal simulator 420. For example, the third sensor 450 may detect a pressure applied to the damper 422 of the pedal simulator 420.

The acceleration device 460 performs acceleration of the vehicle under control of the controller 470. The acceleration device 460 may include a powertrain of the vehicle.

The controller 470 may accelerate the vehicle using at least one of sensing information of the first sensor 430, sensing information of the second sensor 440, or sensing information of the third sensor 450. For example, the controller 470 may determine a magnitude of displacement of the pedal 410 using at least one of the sensing information of the first sensor 430, the sensing information of the second sensor 440, or the sensing information of the third sensor 450, and may control the acceleration device 460 such that acceleration corresponding thereto is achieved.

If a difference between the sensing information of the first sensor 430 and the sensing information of the second sensor 440, a difference between the sensing information of the first sensor 430 and the sensing information of the third sensor 450, and a difference between the sensing information of the second sensor 440 and the sensing information of the third sensor 450 are all within a set range, the controller 470 may accelerate the vehicle based on an average value of the sensing information of the first sensor 430, the sensing information of the second sensor 440, and the sensing information of the third sensor 450.

For example, the set range may be set to a maximum error of the sensing information when the first sensor 430, the second sensor 440, and the third sensor 450 are all normal.

Next, if a difference between the sensing information of the first sensor 430 and the sensing information of the second sensor 440, a difference between the sensing information of the first sensor 430 and the sensing information of the third sensor 450, and a difference between the sensing information of the second sensor 440 and the sensing information of the third sensor 450 are all within the set range, the controller 470 may accelerate the vehicle based on one of the sensing information of the first sensor 430, the sensing information of the second sensor 440, or the sensing information of the third sensor 450. In this regard, the controller 470 may store setting information regarding a priority among the sensors.

Next, when two of a difference between the sensing information of the first sensor 430 and the sensing information of the second sensor 440, a difference between the sensing information of the first sensor 430 and the sensing information of the third sensor 450, and a difference between the sensing information of the second sensor 440 and the sensing information of the third sensor 450 are outside the set range, the controller 470 may determine, as faulty, a sensor outputting sensing information commonly included in the two differences outside the set range among the first sensor 430, the second sensor 440, and the third sensor 450. In addition, the controller 470 may exclude the sensing information of the sensor determined as faulty from a basis of determination.

Meanwhile, if a difference between the sensing information of the first sensor 430 and the sensing information of the second sensor 440, a difference between the sensing information of the first sensor 430 and the sensing information of the third sensor 450, and a difference between the sensing information of the second sensor 440 and the sensing information of the third sensor 450 are all outside the set range, it is difficult to accurately identify the sensing information. In such a case, it is desirable, for safety, that insufficient acceleration rather than excessive acceleration be performed. Accordingly, the controller 470 may accelerate the vehicle based on the smallest value among the sensing information of the first sensor 430, the sensing information of the second sensor 440, and the sensing information of the third sensor 450. Meanwhile, the controller 470 may also perform braking control such that the vehicle is stopped.

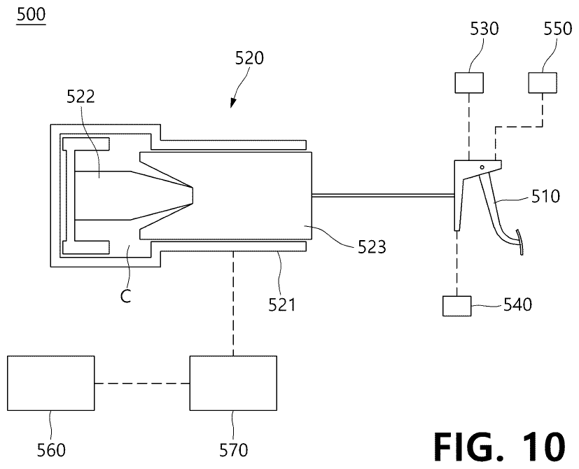

FIG. 10 is a view illustrating a configuration of a pedal system for a vehicle according to a fifth embodiment of the present disclosure.

Referring to FIG. 10, the pedal system 500 for a vehicle according to the fifth embodiment of the present disclosure may include a pedal 510, a pedal simulator 520, a first pedal sensor 530, a second pedal sensor 540, a third pedal sensor 550, an acceleration device 560, and a controller 570.

The pedal 510 may be an accelerator pedal mounted to the vehicle. The pedal simulator 520 is connected to the pedal 510 and provides, to the pedal 510, a reaction force corresponding to a pressure applied to the pedal 510. The pedal simulator 520 may include a housing 521 defining a chamber C therein, a damper 522 disposed inside the housing 521, and a piston 523 connected to the pedal 510 and disposed in the chamber C to press the damper 522 when pressure is applied to the pedal 510.

The first pedal sensor 530 detects information related to operation of the pedal 510. The first pedal sensor 530 may be connected to the pedal 510. For example, the first pedal sensor 530 may detect linear displacement of the pedal 510.

The second pedal sensor 540 is separately disposed from the first pedal sensor 530 and detects information related to operation of the pedal 510. For example, the second pedal sensor 540 may detect angular displacement of the pedal 510.

The third pedal sensor 550 is separately disposed from the first pedal sensor 530 and the second pedal sensor 540. The third pedal sensor 550 detects information related to operation of the pedal 510. For example, the third pedal sensor 550 may detect a force applied to the pedal 510.

The acceleration device 560 performs acceleration of the vehicle under control of the controller 570. The acceleration device 560 may include a powertrain of the vehicle.

If a difference between the sensing information of the first pedal sensor 530 and the sensing information of the second pedal sensor 540, a difference between the sensing information of the first pedal sensor 530 and the sensing information of the third pedal sensor 550, and a difference between the sensing information of the second pedal sensor 540 and the sensing information of the third pedal sensor 550 are all within a set range, the controller 570 may accelerate the vehicle based on an average value of the sensing information of the first pedal sensor 530, the sensing information of the second pedal sensor 540, and the sensing information of the third pedal sensor 550.

Next, if a difference between the sensing information of the first pedal sensor 530 and the sensing information of the second pedal sensor 540, a difference between the sensing information of the first pedal sensor 530 and the sensing information of the third pedal sensor 550, and a difference between the sensing information of the second pedal sensor 540 and the sensing information of the third pedal sensor 550 are all within the set range, the controller 570 may accelerate the vehicle based on one of the sensing information of the first pedal sensor 530, the sensing information of the second pedal sensor 540, or the sensing information of the third pedal sensor 550. In this regard, the controller 570 may store setting information regarding a priority among the sensors.

Next, when two of a difference between the sensing information of the first pedal sensor 530 and the sensing information of the second pedal sensor 540, a difference between the sensing information of the first pedal sensor 530 and the sensing information of the third pedal sensor 550, and a difference between the sensing information of the second pedal sensor 540 and the sensing information of the third pedal sensor 550 are outside the set range, the controller 570 may determine, as faulty, a sensor outputting sensing information commonly included in the two differences outside the set range among the first pedal sensor 530, the second pedal sensor 540, and the third pedal sensor 550. In addition, the controller 570 may exclude the sensing information of the sensor determined as faulty from a basis of determination.

In addition, if a difference between the sensing information of the first pedal sensor 530 and the sensing information of the second pedal sensor 540, a difference between the sensing information of the first pedal sensor 530 and the sensing information of the third pedal sensor 550, and a difference between the sensing information of the second pedal sensor 540 and the sensing information of the third pedal sensor 550 are all outside the set range, the controller 570 may accelerate the vehicle based on the smallest value among the sensing information of the first pedal sensor 530, the sensing information of the second pedal sensor 540, and the sensing information of the third pedal sensor 550. Meanwhile, the controller 570 may also perform braking control such that the vehicle is stopped.

Meanwhile, in addition to the fourth embodiment or the fifth embodiment of the present disclosure, in an accelerator pedal system for a vehicle, it may also be considered that one sensor is disposed in the pedal simulator and two sensors are disposed on a pedal side. In addition, it may also be considered that three sensors are disposed in the pedal simulator.

With the above configuration, the pedal system for a vehicle according to the present disclosure improves recognition accuracy of pedal operation information of the vehicle through determination based on a plurality of pieces of sensing information.

The pedal system for a vehicle according to the present disclosure secures redundancy related to recognition of pedal operation of the vehicle through a plurality of sensors and improves reliability of a recognition function of pedal operation information.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A pedal system for a vehicle, comprising:
a pedal mounted to the vehicle;
a pedal simulator connected to the pedal and configured to provide, to the pedal, a reaction force corresponding to a pressure applied to the pedal;
a first sensor configured to detect information related to operation of the pedal;
a second sensor configured to detect information related to operation of the pedal simulator;
a third sensor configured to detect, separately from the first sensor and the second sensor, information related to operation of the pedal or the pedal simulator; and
a controller configured to operate the vehicle using at least one of sensing information of the first sensor, sensing information of the second sensor, or sensing information of the third sensor.

2. The pedal system of claim 1, wherein the third sensor is configured to detect, separately from the first sensor, information related to operation of the pedal.

3. The pedal system of claim 1, wherein the third sensor is configured to detect, separately from the second sensor, information related to operation of the pedal simulator.

4. The pedal system of claim 1, wherein the controller is configured to brake or accelerate the vehicle based on an average value of the sensing information of the first sensor, the sensing information of the second sensor, and the sensing information of the third sensor if a difference between the sensing information of the first sensor and the sensing information of the second sensor, a difference between the sensing information of the first sensor and the sensing information of the third sensor, and a difference between the sensing information of the second sensor and the sensing information of the third sensor are all within a set range.

5. The pedal system of claim 1, wherein the controller is configured to brake or accelerate the vehicle based on one of the sensing information of the first sensor, the sensing information of the second sensor, or the sensing information of the third sensor if a difference between the sensing information of the first sensor and the sensing information of the second sensor, a difference between the sensing information of the first sensor and the sensing information of the third sensor, and a difference between the sensing information of the second sensor and the sensing information of the third sensor are all within a set range.

6. The pedal system of claim 1, wherein, when two of a difference between the sensing information of the first sensor and the sensing information of the second sensor, a difference between the sensing information of the first sensor and the sensing information of the third sensor, and a difference between the sensing information of the second sensor and the sensing information of the third sensor are outside a set range, the controller is configured to determine, as faulty, a sensor outputting sensing information commonly included in the two differences outside the set range among the first sensor, the second sensor, and the third sensor, and exclude the sensing information of the sensor determined as faulty from a basis of determination.

7. The pedal system of claim 1,
wherein the pedal is a brake pedal, and
wherein the controller is configured to brake the vehicle based on the greatest value among the sensing information of the first sensor, the sensing information of the second sensor, and the sensing information of the third sensor if a difference between the sensing information of the first sensor and the sensing information of the second sensor, a difference between the sensing information of the first sensor and the sensing information of the third sensor, and a difference between the sensing information of the second sensor and the sensing information of the third sensor are all outside a set range.

8. The pedal system of claim 1,
wherein the pedal is an accelerator pedal, and
wherein the controller is configured to accelerate the vehicle based on the smallest value among the sensing information of the first sensor, the sensing information of the second sensor, and the sensing information of the third sensor if a difference between the sensing information of the first sensor and the sensing information of the second sensor, a difference between the sensing information of the first sensor and the sensing information of the third sensor, and a difference between the sensing information of the second sensor and the sensing information of the third sensor are all outside a set range.

9. A pedal system for a vehicle, comprising:
a pedal mounted to the vehicle;
a pedal simulator connected to the pedal and configured to provide a reaction force corresponding to a pressure applied to the pedal;
a first pedal simulator sensor disposed in the pedal simulator and configured to detect information related to operation of the pedal simulator;
a second pedal simulator sensor separately disposed in the pedal simulator from the first pedal simulator sensor and configured to detect information related to operation of the pedal simulator;
a third pedal simulator sensor separately disposed in the pedal simulator from the first pedal simulator sensor and the second pedal simulator sensor and configured to detect information related to operation of the pedal simulator; and
a controller configured to operate the vehicle using at least one of sensing information of the first pedal simulator sensor, sensing information of the second pedal simulator sensor, or sensing information of the third pedal simulator sensor.

10. The pedal system of claim 9, wherein the controller is configured to brake or accelerate the vehicle based on an average value of the sensing information of the first pedal simulator sensor, the sensing information of the second pedal simulator sensor, and the sensing information of the third pedal simulator sensor if a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are all within a set range.

11. The pedal system of claim 9, wherein the controller is configured to brake or accelerate the vehicle based on one of the sensing information of the first pedal simulator sensor, the sensing information of the second pedal simulator sensor, or the sensing information of the third pedal simulator sensor if a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are all within a set range.

12. The pedal system of claim 9, wherein, when two of a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are outside a set range, the controller is configured to determine, as faulty, a sensor outputting sensing information commonly included in the two differences outside the set range among the first pedal simulator sensor, the second pedal simulator sensor, and the third pedal simulator sensor, and exclude the sensing information of the sensor determined as faulty from a basis of determination.

13. The pedal system of claim 9,
wherein the pedal is a brake pedal, and
wherein the controller is configured to brake the vehicle based on the greatest value among the sensing information of the first pedal simulator sensor, the sensing information of the second pedal simulator sensor, and the sensing information of the third pedal simulator sensor if a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are all outside a set range.

14. The pedal system of claim 9,
wherein the pedal is an accelerator pedal, and
wherein the controller is configured to accelerate the vehicle based on the smallest value among the sensing information of the first pedal simulator sensor, the sensing information of the second pedal simulator sensor, and the sensing information of the third pedal simulator sensor if a difference between the sensing information of the first pedal simulator sensor and the sensing information of the second pedal simulator sensor, a difference between the sensing information of the first pedal simulator sensor and the sensing information of the third pedal simulator sensor, and a difference between the sensing information of the second pedal simulator sensor and the sensing information of the third pedal simulator sensor are all outside a set range.

15. A pedal system for a vehicle, comprising:
a pedal mounted to the vehicle;
a pedal simulator connected to the pedal and configured to provide a reaction force corresponding to a pressure applied to the pedal;
a first pedal sensor configured to detect information related to operation of the pedal;
a second pedal sensor separately disposed from the first pedal sensor and configured to detect information related to operation of the pedal;
a third pedal sensor separately disposed from the first pedal sensor and the second pedal sensor and configured to detect information related to operation of the pedal; and
a controller configured to operate the vehicle using at least one of sensing information of the first pedal sensor, sensing information of the second pedal sensor, or sensing information of the third pedal sensor.

16. The pedal system of claim 15, wherein the controller is configured to brake or accelerate the vehicle based on an average value of the sensing information of the first pedal sensor, the sensing information of the second pedal sensor, and the sensing information of the third pedal sensor if a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are all within a set range.

17. The pedal system of claim 15, wherein the controller is configured to brake or accelerate the vehicle based on one of the sensing information of the first pedal sensor, the sensing information of the second pedal sensor, or the sensing information of the third pedal sensor if a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are all within a set range.

18. The pedal system of claim 15, wherein, when two of a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are outside a set range, the controller is configured to determine, as faulty, a sensor outputting sensing information commonly included in the two differences outside the set range among the first pedal sensor, the second pedal sensor, and the third pedal sensor, and exclude the sensing information of the sensor determined as faulty from a basis of determination.

19. The pedal system of claim 15,
wherein the pedal is a brake pedal, and
wherein the controller is configured to brake the vehicle based on the greatest value among the sensing information of the first pedal sensor, the sensing information of the second pedal sensor, and the sensing information of the third pedal sensor if a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are all outside a set range.

20. The pedal system of claim 15,
wherein the pedal is an accelerator pedal, and
wherein the controller is configured to accelerate the vehicle based on the smallest value among the sensing information of the first pedal sensor, the sensing information of the second pedal sensor, and the sensing information of the third pedal sensor if a difference between the sensing information of the first pedal sensor and the sensing information of the second pedal sensor, a difference between the sensing information of the first pedal sensor and the sensing information of the third pedal sensor, and a difference between the sensing information of the second pedal sensor and the sensing information of the third pedal sensor are all outside a set range.
